(19) United States
(12) Patent Application Publication
(10) Pub. No.: US 2019/0362585 A1
(43) Pub. Date: Nov. 28, 2019

(54) VENDING MACHINE HAVING A TRANSPARENT DISPLAY

(71) Applicant: Manufacturing Resources International, Inc., Alpharetta, GA (US)

(72) Inventor: Marcos Diaz, Alpharetta, GA (US)

(21) Appl. No.: 16/533,929

(22) Filed: Aug. 7, 2019

Related U.S. Application Data
(63) Continuation of application No. 15/448,178, filed on Mar. 2, 2017.
(60) Provisional application No. 62/302,228, filed on Mar. 2, 2016.

(51) Int. Cl. G07F 9/02; G07F 9/10; G09G 3/3208; G07F 11/00

(52) U.S. Cl. CPC G07F 9/023; G07F 9/10; G09G 2300/04; G07F 11/00; G09G 3/3208

(57) ABSTRACT

A vending machine showcases and dispenses retails goods from a storage compartment while displaying images on a transparent electronic display. The transparent electronic display being located behind, spaced apart from, and substantially parallel to the cover panel. A door frame houses the cover panel and the transparent electronic display. Masking brackets are secured to the front surface of said transparent electronic display and an inner surface of said cover panel or said door frame and obstruct the view beyond said masking brackets.

### CROSS-REFERENCE TO RELATED APPLICATIONS

This application claims the benefit of U.S. Non-Provisional patent application Ser. No. 15/448,178 filed Mar. 2, 2017, which claims the benefit of U.S. Provisional Patent Application No. 62/302,228 filed Mar. 2, 2016, the disclosures of each of which are hereby incorporated by reference.

### TECHNICAL FIELD

Embodiments of the present invention generally relate to vending machines having electronic displays.

### BACKGROUND

Vending machines have long been used to sell food and drink items. Recently, vending machines have expanded to include the sales of various retail products. Vending machines are typically placed in locations of high public traffic so as to maximize exposure to potential customers. Vending machines often include a transparent customer-facing panel so that the customer may view the items stored within. These transparent panels expose the products stored within to sunlight and other ambient conditions. Alternatively, some vending machines feature a large graphic on the customer-facing panel displaying the likeness of items stored within. The graphic may be displayed on a poster or be integrated with the customer-facing panel. However, these displays provide only static images and cannot be changed without significant effort.

### SUMMARY OF THE INVENTIVE CONCEPT

Exemplary embodiments may comprise a vending machine having a transparent electronic display integrated therewith. The vending machine may comprise a storage area for holding various retail items and a door frame assembly. The transparent electronic display may be integrated with the door frame assembly. The transparent electronic display may be an organic light emitting diode (OLED) type display. The electronic display may be bonded or otherwise adhered to metal brackets which are attached to the door frame assembly. The vending machine may further comprise a control device that alters the transparency level of the transparent electronic display as well as controls the content displayed thereon. The transparent display may permit the customer to view the products stored within the vending machine as well as display graphical content such as videos and images. The transparent display may also be set to various levels of opacity to control the exposure of the products stored within to sunlight and other ambient conditions.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a front perspective view of an exemplary embodiment of the vending machine also indicating section line A-A and section line B-B.

FIG. 2 is a side perspective, sectional view of the device of FIG. 1 taken along section line B-B and also indicating Detail A.

FIG. 3 is a detailed perspective view of Detail A shown in in FIG. 2.

FIG. 4 is a side perspective, sectional view of another exemplary embodiment of the device of FIG. 1 taken along section line B-B and also indicating Detail B and Detail C.

FIG. 5 is a detailed perspective view of Detail B shown in in FIG. 4.

FIG. 6 is a detailed perspective view of Detail C shown in in FIG. 4.

FIG. 7 is a top perspective, sectional view of the device of FIG. 1 taken along section line A-A and indicating Detail D.

FIG. 8 is a detailed perspective view of Detail D shown in FIG. 7.

FIG. 9 is a top perspective, sectional view of another exemplary embodiment of the device of FIG. 1 taken along section line A-A and indicating Detail E and Detail F.

FIG. 10 is a detailed perspective view of Detail E shown in FIG. 9.

FIG. 11 is a detailed perspective view of Detail F shown in FIG. 9.

FIG. 12 is a detailed rear perspective view of Detail F shown in FIG. 9.

FIG. 13 is a detailed rear perspective view of Detail E shown in FIG. 9.

FIG. 14 is a rear view of the door assembly also indicating Detail G.

FIG. 15 is a detailed view of Detail G shown in FIG. 14.

### DETAILED DESCRIPTION OF EXEMPLARY EMBODIMENT(S)

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/ or components, but do not preclude the presence or addition of one or more other features, integers, steps, operations, elements, components, and/or groups thereof.

Embodiments of the invention are described herein with reference to illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

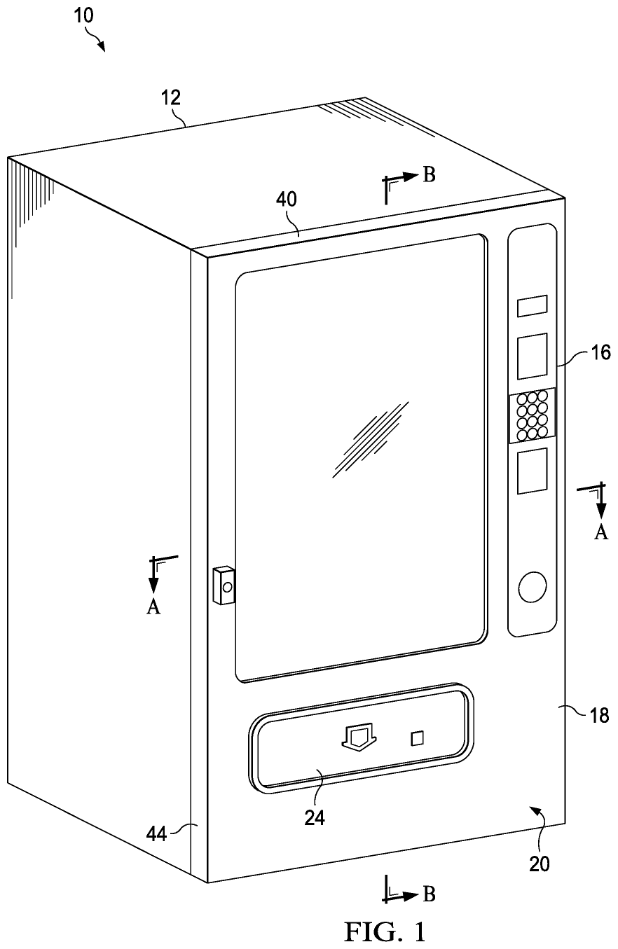

FIG. 1 In an exemplary embodiment of the present invention, a vending machine, indicated generally at 10, comprises a storage cabinet 12 and a door assembly 20. The storage cabinet 12 and the door assembly 20 may be attached to one another in a hinged manner such that when the door assembly 20 is placed in a closed position the storage cabinet 12 is enclosed. The door assembly 20 may be placed in an opened position for maintenance and to restock the various retail items located in the storage cabinet 12.

Any size and shape storage cabinet 12 is contemplated. The door assembly 20 may be comprised of a frame 18 having a number of apertures, including an aperture for a dispensing device 24. The dispensing device 24 may include a hinged panel located atop the aperture. Alternatively, the dispensing device 24 may be an interior compartment with an aperture facing the customer such that the customer may reach in and take the item dispensed therefrom. The dispensing device 24 may fit an oval shaped aperture, though any size or shape aperture and dispensing device 24 are contemplated. The dispensing device 24 may be located towards the bottom of the door assembly 20, though any location is contemplated.

The door assembly 20 may additionally include a user interface 16. The interface 16 may be comprised of display screens, buttons, knobs, dials, key pads, and the like which are configured to permit the customer to select a particular product to be vended and provide payment, if required. The user interface 16 may provide other information such as what item has been selected, payment information, and the like. As will be described in greater detail, the frame 18 may surround the perimeter of a front panel 26 and an electronic display 28.

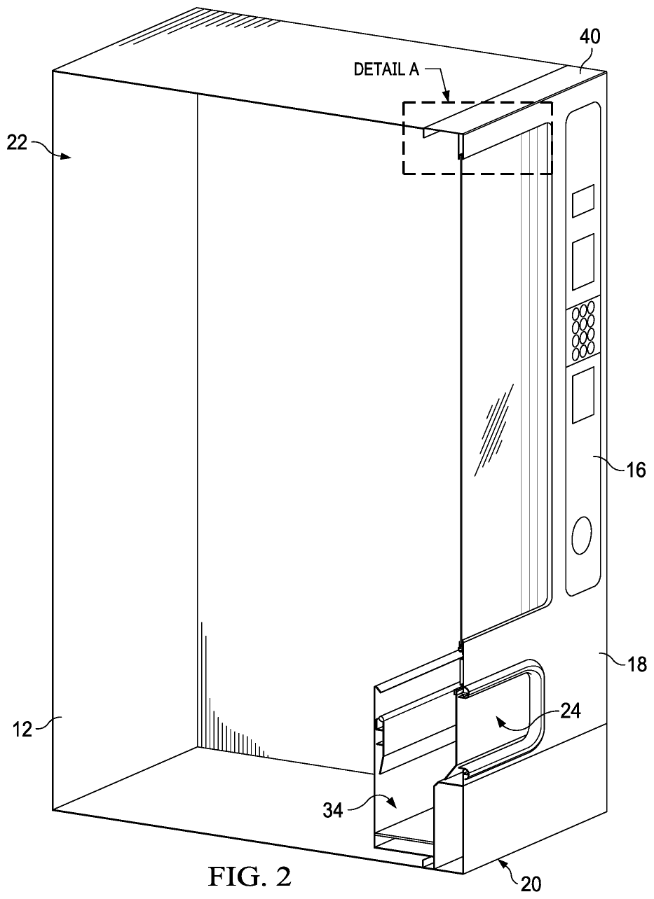

FIG. 2 The storage cabinet 12 may define a storage compartment 22 located behind the door assembly 20. The storage compartment 22 may be any shape or size and may be configured to house a variety of retail items, including but not limited to, food products, beverages, electronics, clothing, fasteners, safety equipment, and the like. The storage compartment 22 may comprise a number of shelves, racks, or the like for storing, showcasing, and selectively dispensing the retail items stored therein.

In exemplary embodiments, the dispensing device 24 may comprise a trough 34 formed between the door assembly 20 and the storage compartment 22. The door assembly 20 may include a U-shaped trough 34 formed from the rear surface of the frame 18 and a panel that extends into the storage compartment 22 and up therefrom, thereby forming a “U”. The vended products may be deposited into the trough 34 and retrieved through the dispensing device 24 aperture. Any size, shape, and location of the trough 34 or other dispensing device 24 is contemplated.

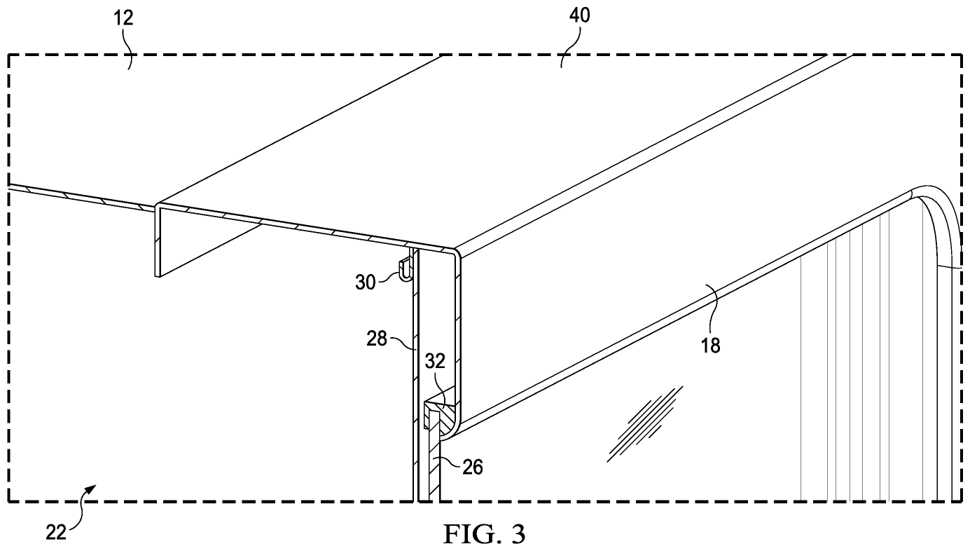

FIG. 3 The exemplary embodiments of the vending machine 10 may be comprised of the front panel 26 and the electronic display 28. The front panel 26 may be a transparent panel comprised of glass, a polymer, or the like. Preferably, the front panel 26 may be comprised of two panels of glass laminated together. The front panel 26 may be fit within a corresponding groove 32 which is bonded to or integrally formed with the frame 18 of the door assembly 20. The groove 32 may extend around various portions of the front panel 26 perimeter, but it is not necessary for the groove 32 to surround the entire perimeter of the front panel 26. In other exemplary embodiments of the present invention, the front panel 26 may be bonded or adhered directly to the frame 18. The front panel 26 may have a smaller vertical height than the electronic display 28, though any size or shape front panel 26 is contemplated.

The electronic display 28 may be located behind the front panel 26. The electronic display 28 may be a transparent electronic display. In exemplary embodiments of the present invention, the transparent electronic display may be an OLED type display, though other types of electronic displays are contemplated. The electronic display 28 may comprise a glass or polymer substrate. The electronic display 28 may be set to various levels of transparency such that the various retail items stored within the storage compartment 22 may be viewed. Additionally, the various levels of transparency, and thus opacity, may be used to control the exposure of the various retail items to sunlight and other ambient conditions. The transparency level of the electronic display 28 may be programmed by a controller 36.

The frame 18 preferably contains a substantially horizontal plate 40 positioned near the top of the frame 18. A bracket 30 preferably extends downwardly from the underside of the plate 40 and contains a flat front surface that is generally perpendicular to the plate 40. If using an OLED type electronic display 28, the substrate containing the OLED materials is preferably bonded to the flat front surface of the bracket 30. The bonding may be accomplished by an adhesive such as 3M™ VHB™ tape. Alternatively, it is contemplated that the bracket may be integrally formed with the frame 18. The bracket 30 may be comprised of a metallic, such as aluminum or the like. In exemplary embodiments of the present invention, the bracket 30 may be J-shaped, though any shape is contemplated. The curved portion of the “J” may extend inwardly towards the storage compartment 22. The electronic display 28 may be bonded to the stem of the J-shaped bracket 30. The bracket 30 may extend the length of the top edge of the electronic display 28.

In exemplary embodiments of the present invention, the upper edge of the frame 18 may be in the shape of a downward facing “C” such that the open part of the “C” faces downward, though any shape is contemplated. The front panel 26 fitted into the groove 32 may be located at and bonded to the inner surface of the outer extreme of the “C” and the electronic display 28 bonded to the bracket 30 may be located along and bonded to the mid-section of the “C”, which may be the flat plate 40. In exemplary embodiments, the bracket 30 may be bonded or otherwise adhered to the frame 18 at the top of the stem of the J-shaped bracket. Additionally, the bracket 30 may be bonded to the frame 18 at each of the extreme ends of the bracket 30. The outer surface of the inner extreme of the C-shaped frame 18 may be bonded or otherwise adhered to a matching protrusion extending from the storage cabinet 12.

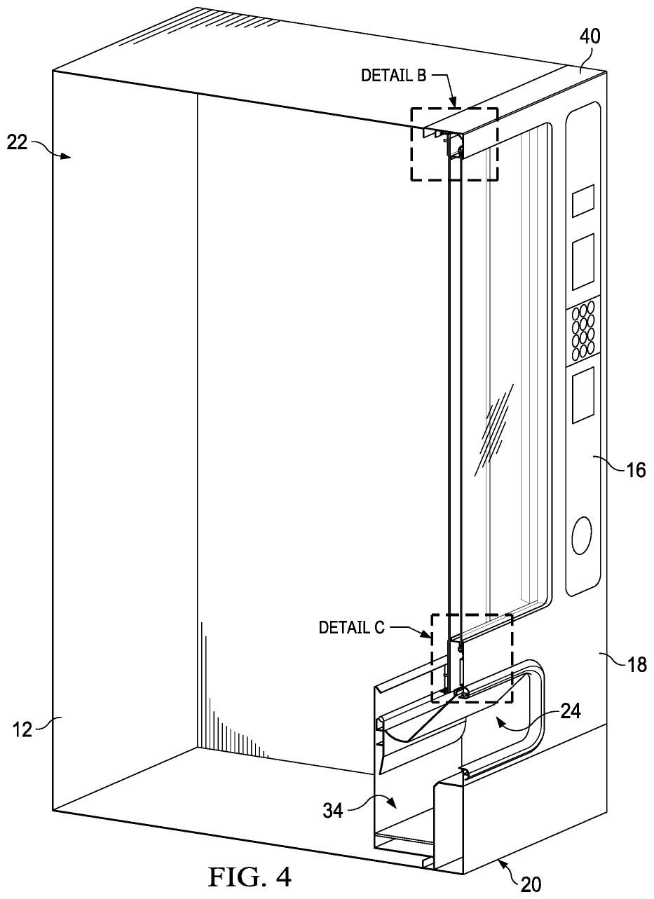

FIG. 4 In other exemplary embodiments of the present invention alternative means for attaching the electronic display 28 to the frame 18 may be utilized.

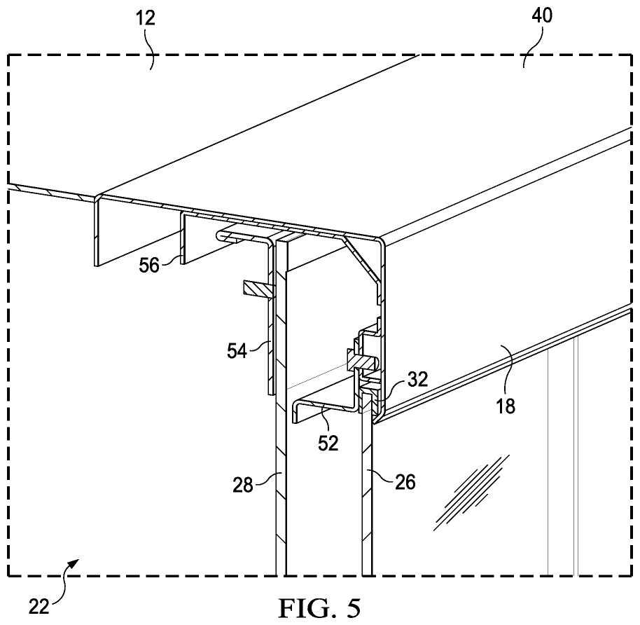

FIG. 5 In one such exemplary embodiment, the electronic display 28 may be bonded to a bracket 54. The bracket 54 may extend along the upper edge of the electronic display 28 and may comprise a flat section that extends in parallel therewith. The electronic display 28 may be bonded to this section of the bracket 54. In embodiments where the OLED type display is utilized, the substrate comprising the OLED materials may be bonded to this section of the bracket 54. In exemplary embodiments of the present invention, the electronic display 28 is bonded to the bracket 54 by use of a double-sided adhesive such as 3M™ VHB™ tape. At substantially the top of the electronic display 28, the bracket 54 may be angled substantially 90 degrees such that the bracket 54 extends into the storage compartment 22. A portion of the bracket 54 which extends into the storage compartment 22 may be folded back onto itself such that it forms a J-shape.

A mask frame 52 may extend between the electronic display 28 and the front panel 26. The mask frame 52 may be configured to hide any elements in the assembly 10 located above the mask frame 52 and between the electronic display 28 and the front cover 26. A portion of the mask frame 52 may extend in parallel with the electronic display 28. In exemplary embodiments of the present invention, this portion of the mask frame 52 may be adhered to a gasket and the gasket may be adhered to the electronic display 28. In exemplary embodiments of the present invention, the gasket may be comprised of rubber, such as neoprene or the like. The mask frame 52 may then extend between and perpendicular to the electronic display 28 and the front cover 26. The mask frame 52 may extend in parallel with the front cover 26 and may be bonded to the groove 32, the frame 18, or both. In exemplary embodiments of the present invention, the mask frame 52 may be black.

A support bracket 56 may extend along and be attached to the customer facing portion of the frame 18. The support bracket 56 may then extend at an angle therefrom until intersecting the plate 40. The support bracket 56 may then extend along, and in parallel with, the inner surface of the plate 40. The end of the support bracket 56 may be angled substantially 90 degrees such that it extends into the storage compartment 22. Preferably, the support bracket 56 extends past the electronic display 28 before extending into the storage compartment 22.

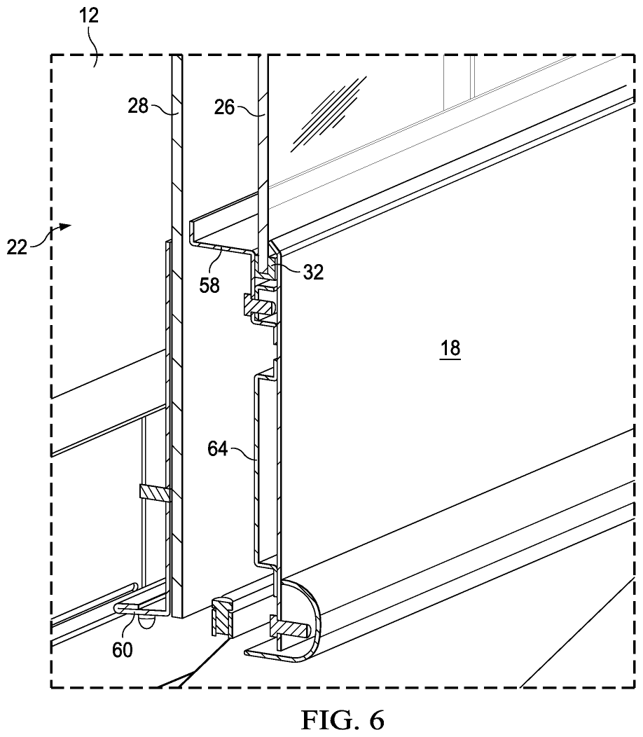

FIG. 6 Similarly, the lower end of the electronic display 28 may be bonded to a bracket 60. A portion of the bracket 60 may extend substantially parallel with and be bonded to the electronic display 28. At the lower edge of the electronic display 28 the bracket 60 may be angled substantially 90 degrees such that it extends into the storage compartment 22. A portion of the bracket 60 that extends into the storage compartment 22 may be folded over itself such that it forms a J-shape. The electronic display 28 may be bonded to the bracket 54 by use of a double-sided adhesive such as 3M™ VHB™ tape.

A lower mask frame 58 similar to mask frame 52 may extend between the electronic display 28 and the front cover 26 and be configured to hide from view any elements located between the electronic display 28 and the front cover 26 and below the frame 18.

A support brace 64 may extend along an inner surface of the customer facing portion of the frame. The support brace 64 may be adhered to the frame 18 at either end. The mid-section of the support brace 64 may be spaced apart from and extend substantially in parallel with the frame 18.

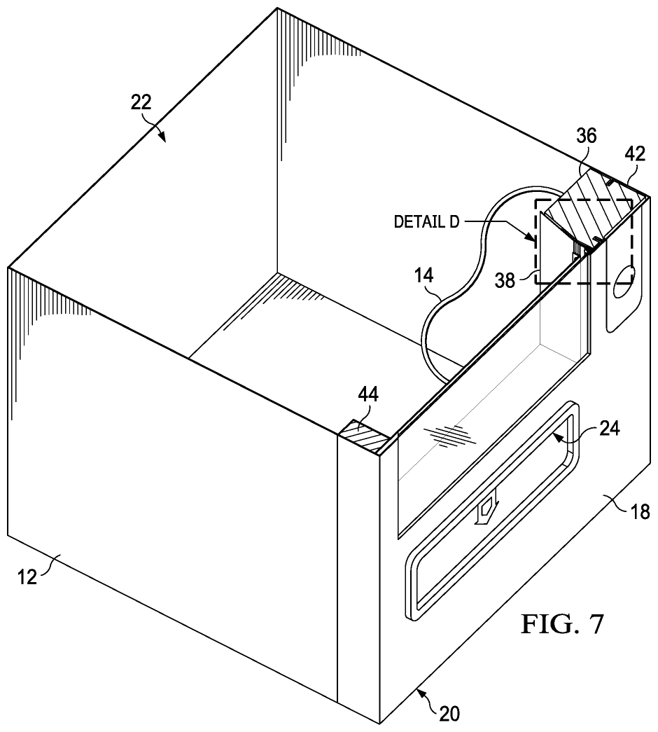

FIG. 7 In exemplary embodiments of the present invention, the frame 18 may likewise be C-shaped along the right edge of the door assembly 20 when viewed from the front. The frame 18 preferably contains a substantially vertical flat plate 42 that extends perpendicularly to the customer facing portion of the frame 18. The customer facing portion of the frame 18 may form one extreme of the “C”. The other extreme of the “C” may comprise a panel extending from the end of the flat plate 42 at a perpendicular angle into the storage compartment 22. The outer surface of this panel may be abutted to the outer surface of a similar panel protruding from the storage cabinet 12 and the two may be bonded together.

In exemplary embodiments of the present invention, the frame 18 may contain a column 44 along the left edge of the door assembly 20 when viewed from the front. The column 44 may form the side and part of the customer facing portion of the frame 18. A portion of the outer surface of the column 44 that faces the storage compartment 22 and extends in parallel to the customer facing portion of the frame 18 may be bonded to an abutting panel that extends from the storage cabinet 12. Alternatively, the frame 18 may be formed around a portion of the column 20 and bonded thereto.

The controller 36 may be located in the storage compartment 22 and is preferably in electrical communication with the electronic display 28 such as by a wire 14, wireless communication, or the like. The controller 36 may be configured to control the content displayed on the electronic display 28 as well as operate the user interface 16. The controller 36 may comprise various electronic components including, but not limited to, the following: a timing and control board, video player, hard drive/storage, microprocessor/CPU, wireless transmitter/receiver, and internet connectivity. In other exemplary embodiments of the present invention, the controller 36 may be located in or otherwise integrated with the electronic display 28.

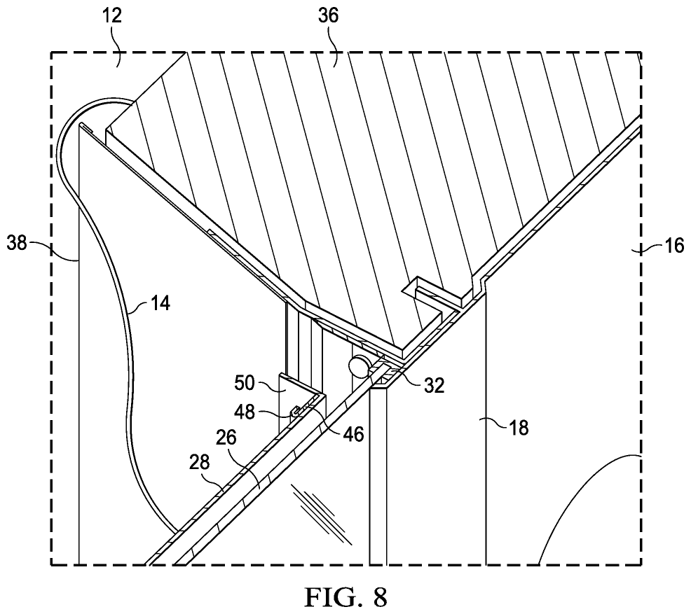

FIG. 8 The sides of the electronic display 28 may likewise be bonded to side brackets 46. In exemplary embodiments of the present invention, the side brackets 46 comprise a flat portion 50 and a J-shaped portion 48, where the stem of the J-shaped portion 48 is located at the edge of the flat portion 50 nearest the front panel 26 and where the J-shaped portion 48 extends at a perpendicular angle from the flat portion 50. The curve of the J-shaped portion 48 may extend into the storage compartment 22. If using an OLED type electronic display 28, the substrate containing the OLED materials is preferably bonded to the flat front surface of the side brackets 46, which in exemplary embodiments is the stem of the J-shaped portion 48.

The side brackets 46 may extend the length of the sides of the electronic display 28 and may be bonded to the frame 18 at the top and bottom surfaces of the side brackets 46. Similarly, the sides of the front panel 26 may be fitted into the groove 32 bonded or otherwise adhered to the frame 18. The electronic display 28 may have a smaller horizontal width than the front panel 26, though any size and shape electronic display 28 is contemplated.

A divider 38 may be located between the electronic display 28 and the user interface 16. The divider 38 may extend from the frame 18 into the storage compartment 22. In exemplary embodiments, the controller 36 is located on the right side of the divider 38 when viewed from the front. In other exemplary embodiments, the controller 36 is located on a bottom surface of the storage cabinet 12. Any location for the controller 36 is contemplated.

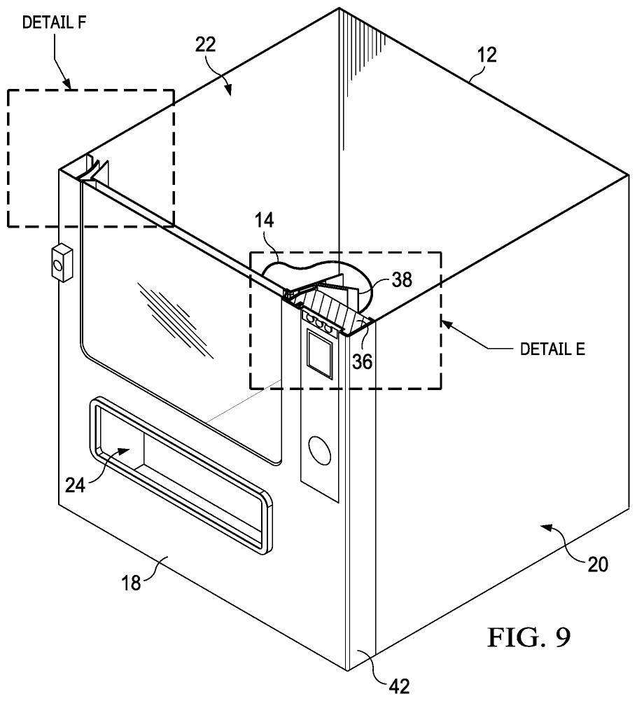

FIG. 9 In other exemplary embodiments of the present invention alternative means for attaching the electronic display 28 to the frame 18 may be utilized.

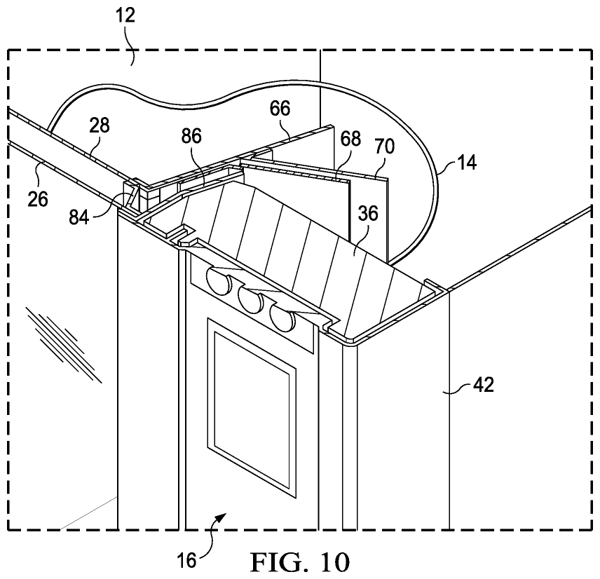

FIG. 10 In one such exemplary embodiment, a pair of side mask frames 84, similar to mask frame 52 and lower mask frame 58, may extend on either side of the door assembly 20 between the electronic display 28 and the front cover 26. In exemplary embodiments of the present invention, the side mask frames 84 may be substantially “Z” or “S” shaped such that the top surface of the Z or S is bonded to the electronic display, the mid-section of the Z or S extends between the electronic display 28 and the front cover 26, and the bottom surface of the Z or S is bonded to the front cover 26.

A pair of lighting panels 66 may extend vertically within the storage compartment 22 on either side of the electronic display 28. One of said lighting panels 66 may be located between the controller 36 and the electronic display 28 and may extend at an obtuse angle relative to the electronic display 28. The leading edge of the lighting panel 66 may be attached to the electronic display 28. The trailing edge of the lighting panel 66 may be folded over itself such that it forms a J-shape.

A support bracket 70 may also extend vertically within the storage compartment 22. The support bracket 70 may be affixed to and extend at an angle from the lighting panel 66 towards the controller 36. The trailing edge of the support bracket 70 may be folded over itself such that it forms a J-shape.

A divider 68 may be similar to divider 38 and may extend vertically within the storage compartment to separate the controller 36 and the interface 16 from the electronic display 28 and the remainder of the storage compartment 22. The divider 68 may be attached to the support bracket 70 or the lighting panel 66. A portion of the divider 68 may extend in parallel with the lighting panel 66 and a portion of the divider 68 may extend in parallel with the support bracket 70.

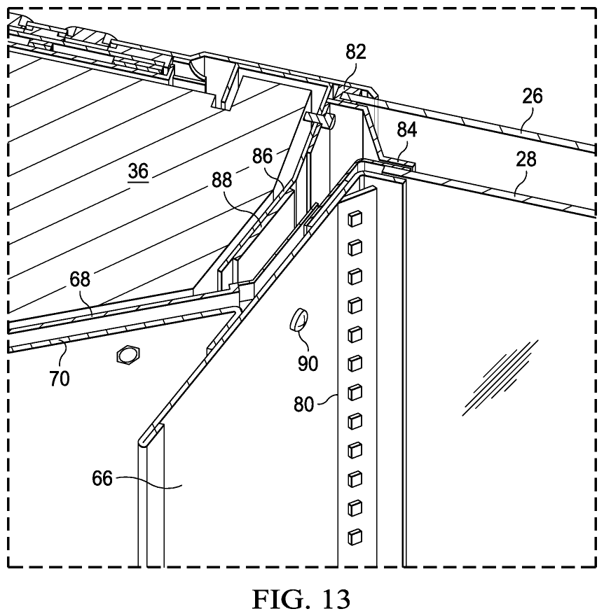

As further illustrated in FIG. 13, an additional support member 86 may extend vertically within the storage compartment 22. A first portion of the additional support member 86 may extend into the compartment behind the interface 16. A second portion of the additional support member 86 may extend parallel with and be bonded to the customer facing portion of the frame 18. A third portion of the additional support member 86 may extend from the customer facing portion of the frame 18 at a perpendicular angle. A fourth portion of the additional support member 86 may angle towards the controller 36. The additional support member 86 may be formed around the edge of the controller 36.

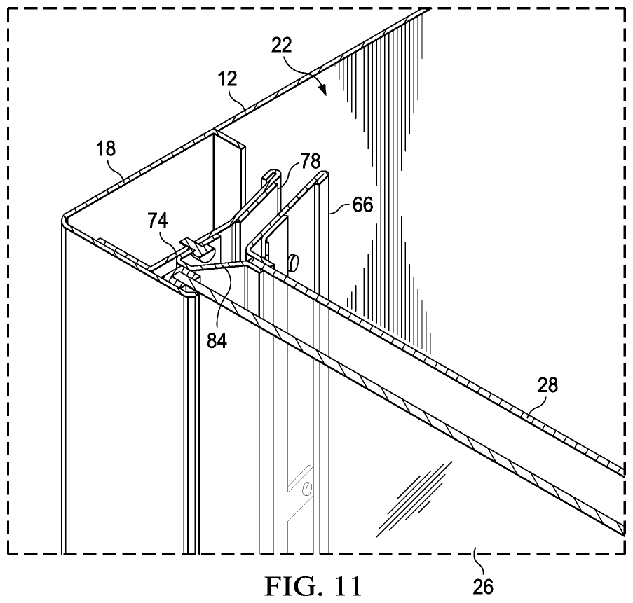

FIG. 11 Similarly, the other side of the assembly 10 may comprise another lighting panel 66 and side mask frame 84. A portion of the lighting panel 66 may extend in parallel with and be bonded to the electronic display 28. The remainder of the lighting panel 66 may extend at an obtuse angle from the electronic display 28 into the storage compartment 22.

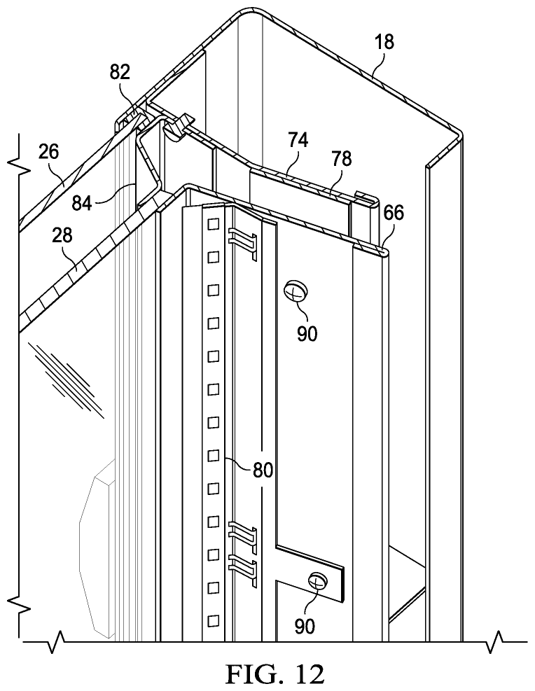

As further illustrated in FIG. 12, a support bracket 74 may extend vertically within the storage compartment 22. A first portion of the support bracket 74 may extend parallel with the customer facing portion of the frame 18 and be bonded thereto. A second portion of the support bracket 74 may extend outwardly from the customer facing portion of the frame 18 into the storage compartment 22. A third portion of the support bracket 74 may extend at an obtuse angle from the electronic display 28 such that it extends substantially in parallel with the lighting panel 66. A portion of the trailing edge of the support bracket 74 may fold over itself such that it forms a J-shape.

In exemplary embodiments of the present invention, a reinforcement member 78 may be attached to the support bracket 74. The reinforcement member 78 may be C-shaped such that each end of the C is bonded to the support bracket 74 and the mid-section of the C extends in parallel with, and spaced apart from, the support bracket 74.

FIG. 12 A rear view of FIG. 11 reveals a lighting strip 80. The lighting strip 80 may comprise a series of illumination devices mounted to a bracket. The lighting strip 80 may be mounted at an angle between the portion of the lighting panel 66 that extends in parallel with the electronic display 28 and the portion that extends at an angle therefrom. The illumination devices may include, but are not limited to, light emitting diodes (LEDs). The illumination devices may be used to illuminate the products stored within the storage compartment 22. The lighting strips 80 may be in communication with the controller 36 and the controller 36 may control the illumination of the lighting strip 80.

The lighting strip 80 may be bonded to the lighting panel 66 by high temperature pressure sensitive adhesives (PSAs), though any bonding means is contemplated. Alternatively, or in addition, the lighting strip 80 may be secured to the lighting panel by the use of fasteners 90. Likewise, the lighting panel 66 may be attached to the support bracket 74, or the reinforcement member 78 where utilized, by fasteners 90. The fasteners 90 may be screws, nails, or the like.

A side groove 82 similar to groove 32 may receive the side edge of the front panel 26. The side groove 82 may be bonded to the frame 18 and the side mask frames 84. The groove 82 may also be bonded to the support bracket 74.

FIG. 13 A rear view of FIG. 10 likewise reveals the lighting strip 80 mounted at an angle between the portion of the lighting panel 66 that extends in parallel with the electronic display 28 and the portion that extends at an angle therefrom. The support member 86 may similarly comprise a reinforcement member 88. The reinforcement member 88 may be similar to the reinforcement member 78 and likewise may be located on the angled portion of the support bracket 86.

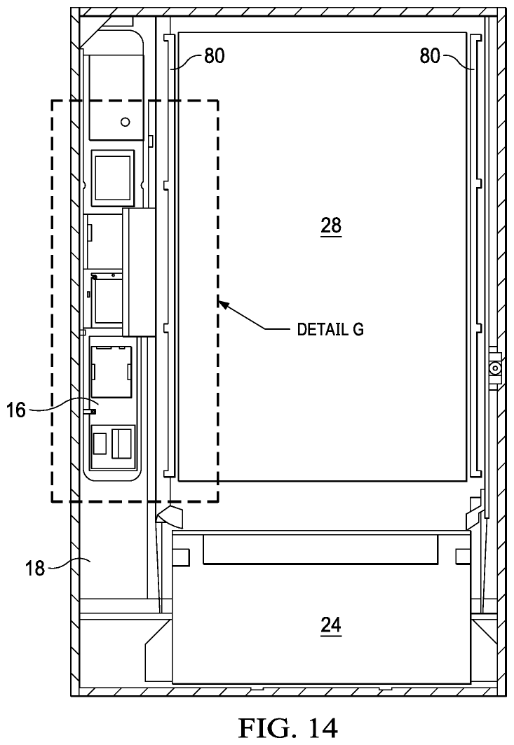

FIG. 14 The pair of lighting strips 80 are located on either side of the electronic display 28 and may be angled such that the pair of lighting strips 80 illuminate the various products stored inside the storage compartment 22.

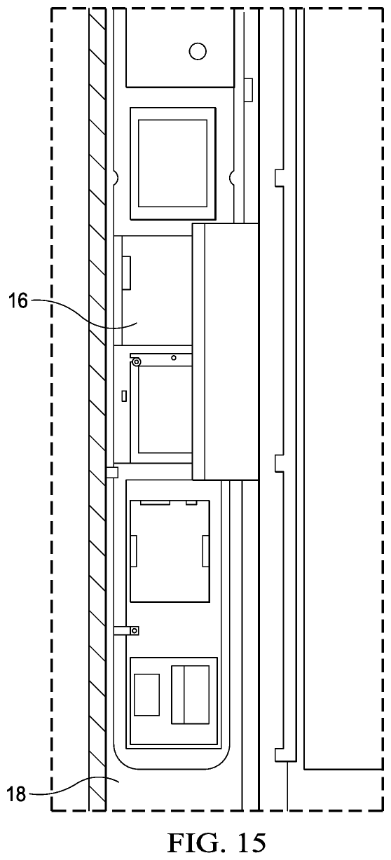

FIG. 15 The interface 16 may be comprised of various electronic components which may be assembled into the frame 18. The various electronic components may include, but are not limited to, printed circuit boards, illumination devices, displays, interfaces, LEDs, currency acceptors, change dispensers, receipt printers, and the like.

Having shown and described a preferred embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is claimed is:

1. A vending machine for showcasing and dispensing retails goods to a user while displaying images comprising:
a storage compartment for the retail goods;
a transparent cover panel;
a transparent electronic display having a front surface and a rear surface, wherein
the transparent electronic display is located behind, spaced apart from, and
substantially parallel with the transparent cover panel;
a housing for the transparent cover panel and the transparent electronic display; and
a plurality of masking brackets each having a first surface secured to the front surface of said transparent electronic display and a second surface secured to an inner surface of said transparent cover panel or said housing.

2. The vending machine of claim 1 wherein:
the transparent electronic display has a smaller surface area than the transparent cover panel.

3. The vending machine of claim 2 wherein:
each of said masking brackets comprise a first, second, and middle portion, wherein:
said first portion extends substantially parallel with the front surface of said transparent electronic display;
said second portion extends substantially parallel with the inner surface of said door frame assembly; and
said middle portion extends between said first and second portions.

4. The vending machine of claim 3 wherein:
each of said middle portions extend at an obtuse angle from said first portion and said second portion.

5. The vending machine of claim 1 wherein:
at least one of said plurality of masking brackets extends along each edge of said transparent electronic display.

6. The vending machine of claim 1 further comprising:
a plurality of display brackets wherein a first surface of each display bracket is secured to a rear surface of the transparent electronic display and a second surface of each display bracket is secured to an inner surface of said housing.

7. The vending machine of claim 1 further comprising:
a plurality of cover panel brackets each substantially surrounding an outer edge of said transparent cover panel and sandwiched between said housing and said masking brackets.

8. The vending machine of claim 7 wherein:
said cover panel brackets are placed around each edge of the transparent cover panel.

9. The vending machine of claim 1 wherein:
said transparent electronic display comprises organic light emitting diodes.

10. The vending machine of claim 1 wherein:
the first surface of each of said display brackets is secured to an upper or lower portion of said transparent electronic display.

11. The vending machine of claim 10 further comprising:
a double-sided adhesive securing the transparent electronic display to said first surface of each of said display brackets.

12. The vending machine of claim 1 further comprising:
a number of lighting elements located in said storage compartment for illuminating the retail goods.

13. The vending machine of claim 12 further comprising:
a number of lighting panels, wherein each of said lighting panels are connected to the rear surface of the transparent electronic display and extend at an obtuse angle from the rear surface into said storage compartment, wherein each of said lighting elements are mounted to one of said lighting panels.

14. A vending machine for showcasing and dispensing retails goods while displaying images comprising:
a storage compartment configured to showcase the retail goods;
a first and second lighting panel located within the storage compartment;
a number of illumination elements located on each of said lighting panels and configured to illuminate the retail goods;
a transparent cover panel;
a transparent electronic display positioned behind, spaced apart from, and substantially parallel to said transparent cover panel;
an access panel assembly housing the transparent cover and the transparent electronic display;
a controller in communication with the transparent electronic display and configured to control the images displayed thereon;
a plurality of masking brackets extending between said transparent electronic display and said transparent cover panel;
a number of display brackets securing said transparent electronic display to said access panel assembly; and
a number of cover panel brackets securing said transparent cover panel to said access panel assembly.

15. The vending machine of claim 14 wherein:
each of said masking brackets comprises a first, second, and third portion, wherein:
said first portion extends along a front surface of the transparent electronic display;
said third portion extends along an inner surface of said access panel assembly; and
said second portion extends between, and at an obtuse angle from, the first portion and the second portion.

16. The vending machine of claim 14 wherein:
the width of the transparent cover panel is greater than the width of the transparent electronic display.

17. The vending machine of claim 14 wherein:
the height of the transparent cover panel is greater than the height of the transparent electronic display.

18. The vending machine of claim 14 wherein:
said transparent electronic display comprises liquid crystals.

19. The vending machine of claim 14 wherein:
said transparent cover panel is comprised of glass.

20. A vending machine for showcasing and dispensing retails goods to a user while displaying images comprising:
a storage compartment configured to showcase and dispense the retail goods upon purchase;
a number of lighting elements configured to illuminate the retail goods;
a user interface configured to allow the user to purchase the retail goods;
a transparent cover panel;
a transparent electronic display positioned behind, spaced apart from, and substantially parallel to said transparent cover panel, wherein said transparent electronic display is configured to display images on said transparent electronic display while also allowing the user to view the retail goods within the storage compartment, and wherein the space between said electronic display assembly as said transparent cover panel defines a gap;
a controller in communication with the transparent electronic display and configured to control the images displayed on the transparent electronic display;
an access panel housing the transparent cover panel, the transparent electronic display, the user interface, and the controller; and
a plurality of masking brackets, each secured to said transparent electronic display at one end and secured to said access panel housing at a second end, wherein said masking brackets are configured to mask at least part of the gap.
